(19) United States
(12) Patent Application Publication
(10) Pub. No.: US 2023/0046916 A1
(43) Pub. Date: Feb. 16, 2023

(54) A LINE TRIMMER ASSEMBLY

(71) Applicant: KRENTEK PTY LTD, Eerwah Vale (AU)

(72) Inventor: Glenn Bischof, Eerwah Vale, Queensland (AU)

(73) Assignee: KRENTEK PTY LTD, Eerwah Vale (AU)

(21) Appl. No.: 17/793,830

(22) PCT Filed: Jan. 20, 2021
(86) PCT No.: PCT/AU2021/050031

§ 371 Date: Jul. 19, 2022

(30) Foreign Application Priority Data
Jan. 21, 2020 (AU) 2020900158

(51) Int. Cl. A01D 43/16

(52) U.S. Cl. CPC A01D 43/16; A01D 2101/00

(57) ABSTRACT

A line trimmer assembly locatable on a vehicle configured to seat an operator, the line trimmer assembly comprising a support assembly comprising a base configured to be attached to the vehicle and a biasing assembly configured to rotate relative to the base, a shaft operably connected to the support assembly and a trimmer head connected to a distal end of the shaft, the trimmer head being configured to cut vegetation, wherein the biasing assembly is configured to enable the shaft to swing laterally between a first position and a second position, and the biasing assembly biases the shaft towards the first position, and wherein the shaft is configured to move between a raised position and a lowered position to allow a distance between the trimmer head and the ground to be adjusted.

### CROSS-REFERENCE TO RELATED APPLICATIONS

This application is a national stage of, and claims priority to, Patent Cooperation Treaty Application No. PCT/AU2021/050031, filed on Jan. 20, 2021, which application claims priority to Australian Provisional Application No. 2020900158, filed on Jan. 21, 2020, which applications are hereby incorporated herein by reference in their entireties.

### FIELD

The disclosure relates to a line trimmer assembly. In particular, the disclosure relates, but is not limited, to a line trimmer assembly locatable on a vehicle and configured to cut vegetation.

### BACKGROUND

Reference to background art herein is not to be construed as an admission that such art constitutes common general knowledge in Australia or elsewhere.

Cutting vegetation (grass, weeds etc) located adjacent to or around structures such as buildings, posts, fences, trees etc is often difficult as typical lawn mowers are unable to reach those areas. Instead, line trimmers are typically used to cut vegetation in such hard-to-reach areas.

The two types of lines trimmers commonly used include handheld line trimmers and wheeled/walk-behind type line trimmers. However, cutting vegetation with a handheld line trimmer is a slow process requiring significant manual input. Further, it is quite difficult to get an even cut with a handheld line trimmer. Wheeled line trimmers, although easier to use relative to handheld trimmers, suffer from some of the same drawbacks as lawn mowers due to their larger size and still require significant manual input from the operator. Moreover, cutting vegetation with a lawn mower and then with a line trimmer is a time-consuming task, often requiring same areas of vegetation to be revisited with both tools for the desired cut.

### SUMMARY

In one form, although not necessarily the only or broadest form, the disclosure resides in a line trimmer assembly locatable on a vehicle configured to seat an operator, the line trimmer assembly comprising:

a support assembly comprising a base configured to be attached to the vehicle and a biasing assembly configured to rotate relative to the base;
a shaft operably connected to the support assembly;
a trimmer head connected to a distal end of the shaft, the trimmer head being configured to cut vegetation;

wherein the biasing assembly is configured to enable the shaft to swing laterally between a first position and a second position, and the biasing assembly biases the shaft towards the first position, and

wherein the shaft is configured to move between a raised position and a lowered position to allow a distance between the trimmer head and the ground to be adjusted.

Preferably, a distance between the trimmer head and a body of the vehicle is greater in the first position than in the second position.

Preferably, the vehicle is a lawn mower. Preferably, the vehicle has a seat for seating an operator. Preferably, the line trimmer assembly is attached to a side portion of the body of the vehicle. Preferably, the line trimmer assembly is attached to a front or rear portion of the body of the vehicle.

Preferably, the base of the support assembly comprises a plate and a tube connected to the plate. Preferably, the plate is shaped as a circular disc. Preferably, the plate has three apertures through which fasteners can be located for attaching the line trimmer assembly to the vehicle. Preferably, the biasing assembly is located on the tube.

Preferably, the base comprises a base plate, an adjusting plate connected to the base plate, and a tube connected to the adjusting plate. Preferably, the base plate has a first plurality of apertures and a second plurality of apertures. Preferably, fasteners can be located through the first plurality of apertures to attach the line trimmer assembly to the vehicle. Preferably, the adjusting plate has a plurality of apertures. Preferably, fasteners can be located through the plurality of apertures of the adjusting plate and the second plurality of apertures of the base plate to attach the adjusting plate to the base plate.

Preferably, biasing assembly comprises a collar, a first bush, a housing, a second bush, a torsion spring and a cap. Preferably, the collar mates with the tube. Preferably, the collar includes a central bore through which the tube extends. Preferably, the collar is non-rotatable with respect to the tube. Preferably, the collar includes two projections. Preferably, the projections of the collar are located on a planar surface of the collar and are spaced from each other.

Preferably, first bush includes a central bore through which the tube extends. Preferably, the first bush is rotatable with respect to the tube and non-rotatable with respect to the housing. Preferably, a first end of the first bush engages with the housing and a second end of the first bush includes two projections spaced from each other. Preferably, the projections of the first bush selectively engage with the projections of the collar.

Preferably, rotational movement of the first bush relative to the collar 121 is limited in either direction along an arc of a predetermined arcuate length such that the lateral swinging of the shaft is also limited along the arc.

Preferably, the housing includes a first side portion and a second side portion, the first and second side portions being connected to each other along a longitudinal side of each side portion.

Preferably, the first side portion has a hollow longitudinal portion with a bore extending along an entire length thereof and a hollow lateral portion with a bore extending along an entire length thereof. Preferably, the first side portion further includes a locking pin that releasably engages with an aperture on the tube of the base.

Preferably, a portion of the first and second bushes and a portion of the tube of the base are received within the bore of the first side portion of the housing. Preferably, an upper end of the bore of the first side portion receives a first end of the second bush. Preferably, a second end of the second bush is attached to the spring and engages with the cap.

Preferably, the spring is enclosed by the cap and the second bush. Preferably, the spring is a coiled compression spring. Preferably, the spring is a torsion spring. Preferably, the spring biases the shaft towards the first position.

Preferably, in the first position, the trimmer head is located at a maximum distance from the body of the vehicle. Preferably, in the second position, the trimmer head is located at a minimum distance from the body of the vehicle. Preferably, the maximum and minimum distances are set by design of the projections of the collar and the first bush.

Preferably, the shaft is lockable in the second position by engaging the locking pin of the first side portion of the housing with the aperture on the tube of the base. Preferably, the shaft is locked in the second position when the line trimmer assembly is not in use or is being transported.

Preferably, the support assembly further comprises a frame connected to the biasing assembly. Preferably, the frame is an A-frame. Preferably, the first and second side portions of the housing are connected to the frame. Preferably, the lateral portion of the first side portion of the housing is connected to the frame.

Preferably, the frame comprises a pair of outer arms and a locking member. Preferably, the locking member is U-shaped. Preferably, the locking member has a locking pin located thereon.

Preferably, the outer arms are connected to parallel arms of the locking member. Preferably, each of the outer arms is connected to a respective arm of the locking member such that a minimum distance between the pair of outer arms is maintained.

Preferably, a distance between the outer arms at proximal ends of the outer arms is such that the outer arms can be connected to the lateral portion of the first side portion of the housing. Preferably, connection of the proximal ends of the outer arms with the first side portion of the housing provides a point about which the shaft is able to pivot to move between the raised position and the lowered position.

Preferably, a connecting member is connected to the outer arms. Preferably, the connecting member is received between distal ends of the outer arms. Preferably, the connecting member connects the frame to the shaft.

Preferably, the second side portion of the housing comprises a hollow longitudinal portion. Preferably, the second side portion has an aperture located on a longitudinal side thereof. Preferably, the locking member of the frame is configured to engage with the aperture of the second side portion. Preferably, when the locking member is engaged with the aperture of the second side portion, the shaft is locked in the raised position. Preferably, the shaft is locked in the raised position when the line trimmer assembly is not in use or is being transported.

Preferably, the second side portion includes two elongate cut-outs, each cut-out being located on a respective longitudinal side of the second side portion. Preferably, a length of each of the cut-outs determines a maximum and minimum distance of the trimmer head from the ground.

Preferably, a floating member is located in the hollow of the second side portion. Preferably, the floating member has two bolts extending from opposite sides thereof. Preferably, the bolts of the floating member extend through the cut-outs of the second side portion. Preferably, the bolts of the floating member are connected to the locking member of the frame.

Preferably, the floating member includes a central bore. Preferably, a spring is located in the bore of the floating member.

Preferably, an elongate adjusting bolt extends through the hollow of the second side portion. Preferably, the adjusting bolt extends through the bore of the floating member. Preferably, the adjusting bolt extends through the spring located in the bore of the floating member. Preferably, an adjusting nut is connected to an end of the adjusting bolt and is moveable along the adjusting bolt relative to the second side portion.

Preferably, the distance between the trimmer head and the ground can be adjusted by the adjusting bolt. Preferably, the spring allows for minor changes in the distance between the trimmer head and the ground when an upward force is exerted on the trimmer head.

Preferably, the shaft comprises a tubular member that extends through a first bush and a second bush. Preferably, the tubular member is hollow.

Preferably, the first bush is connected to the frame by the connecting member. Preferably, the second bush is releasably engageable with the first bush. Preferably, the first bush includes a pair of projections with apertures through which fasteners are located to connect the first bush to the connecting member. Preferably, one of the apertures located on each of the projections of the first bush are elongate in shape such that an angle between the tubular member and the frame can be adjusted.

Preferably, the tubular member is axially slideable relative to the first bush. Preferably, the second bush is clamped onto the tubular member.

Preferably, the first bush includes a plurality of projections at an end of the first bush that engages with the second bush. Preferably, the projections of the first bush are located circumferentially about a longitudinal axis of the tubular member and extend towards the second bush.

Preferably, the second bush includes a plurality of projections at an end of the second bush that engages with the first bush. Preferably, the projections of the second bush are located circumferentially about the longitudinal axis of the tubular member and extend towards the first bush.

Preferably, the projections of the first and second bushes allow the first and second bushes to engage with each other in multiple configurations. Preferably, changing the mating configuration of the first and second bushes allows the tubular member and/or the trimmer head to be rotated about the longitudinal axis of the tubular member.

Preferably, disengagement of the second bush of the shaft from the first bush of the shaft can be detected by a safety switch. Preferably, the safety switch cuts off power supply to the trimmer head when the second bush disengages from the first bush.

Preferably, the distal end of the tubular member includes a gear head with a central throughbore. Preferably, the gear head is connected to the trimmer head. Preferably, a proximal end of the tubular member is connected to a power source. Preferably, the power source is connected to the tubular member via a cable. Preferably, the power source is an electric motor. Preferably, the power source is a motor of the vehicle. Preferably, the power source is a petrol engine. Preferably, the power source is connected to the distal end of the tubular member.

Preferably, a flexible drive shaft extends through the cable and through the tubular member.

Preferably, the trimmer head comprises a cord release assembly. Preferably, the cord release assembly is connected to the gear head at an upper end of the gear head. Preferably, the cord release assembly comprises a plunger, a spring, a magnet and a rod. Preferably, the magnet includes a central throughbore and is attached to the gear head such that the central throughbores of the magnet and the gear head are co-axial.

Preferably, the plunger, the spring and a portion of the rod are located in the throughbore of the magnet. Preferably, the spring is located between the plunger and the rod. Preferably, the spring counteracts the weight of the plunger. Preferably, the plunger and the rod come into contact only when the magnet is activated.

Preferably, the rod extends from the throughbore of the magnet 313, through the throughbore of the gear head 204 and a hollow drive shaft located through the gear head. Preferably, a portion of the rod extends past the drive shaft and engages with the trimmer.

Preferably, a thrust bearing is located in the throughbore of the magnet. Preferably, the thrust bearing is configured such that no rotational force is transferred to the plunger.

Preferably, the floating disc of the trimmer head is located between two immobile discs that are fixed relative to the gear head. Preferably, the floating disc is rotatable relative to the immobile discs and the gear head.

Preferably, the circumferential edge of the floating disc has a series of projections. Preferably, the series of projections extend entirely along the circumferential edge. Preferably, the diameter of the floating disc is greater than a diameter of the two immobile discs such that the circumferential edge of the floating disc extends beyond the two immobile discs.

Preferably, the trimmer of the trimmer head is located at the lower end of the gear head. Preferably, the trimmer is located below the two immobile discs and the floating disc. Preferably, the trimmer includes cord for cutting vegetation. Preferably, the drive shaft connects the trimmer to the gear head. Preferably, rotation of the drive shaft causes the trimmer to rotate.

Preferably, the plunger is pulled towards the rod when the magnet is activated. Preferably, the rod is pushed downwardly towards the trimmer when the magnet is activated. Preferably, the rod is pushed upwardly away from the trimmer when the magnet is activated.

Preferably, the magnet is activated by a switch. Preferably, the switch is located in proximity to the seat of the vehicle. Preferably, switch is located on the line trimmer assembly.

In another form the disclosure resides in a system for cutting vegetation, the system comprising:

a vehicle comprising a seat to seat an operator; and

a line trimmer assembly located on the vehicle, the line trimmer assembly comprising:
a support assembly comprising a base attached to the vehicle and a biasing assembly configured to rotate relative to the base;
a shaft operably connected to the support assembly;
a trimmer head connected to a distal end of the shaft; the trimmer head being configured to cut vegetation;

wherein the biasing assembly is configured to enable the shaft to swing laterally between a first position and a second position, and the biasing assembly biases the shaft towards the first position, and

wherein the shaft is configured to move between a raised position and a lowered position to allow a distance between the trimmer head and the ground to be adjusted.

In another form the disclosure resides in a method for cutting vegetation, the method comprising:

moving a shaft of a line trimmer assembly to a lowered position from a raised position, the shaft having a trimmer head connected to a distal end thereof;

moving the shaft to a first position from a second position, the shaft being biased towards the first position by a biasing assembly operatively connected to the shaft;

activating a trimmer located on the trimmer head, the trimmer being configured to cut vegetation,

wherein the line trimmer assembly is located on a vehicle configured to seat an operator

Preferably, moving the shaft to the lowered position from the raised position includes unlocking the shaft locked in the raised position by a locking pin.

Preferably, moving the shaft to the first position from the second position includes unlocking the shaft locked in the second position by a further locking pin.

Preferably, activating the trimmer includes turning on the line trimmer assembly from a power source.

Preferably, the line trimmer assembly is herein as described.

Further features and advantages of the present disclosure will become apparent from the following detailed description.

### BRIEF DESCRIPTION OF THE DRAWINGS

By way of example only, preferred embodiments of the disclosure will be described more fully hereinafter with reference to the accompanying figures, wherein:

FIG. 1 illustrates a side perspective view of a line trimmer assembly, according to an embodiment of the disclosure, located on and connected to a vehicle;

FIG. 2 illustrates an exploded view of a portion of the support assembly of the line trimmer assembly shown in FIG. 1;

FIG. 3a illustrates a partial view of the support assembly of the line trimmer assembly shown in FIG. 1, when the shaft is in the lowered position;

FIG. 3b illustrates a partial view of the support assembly of the line trimmer assembly shown in FIG. 1, when the shaft is in the raised position;

FIG. 4 illustrates a partial detail view of the support assembly and the shaft of the line trimmer assembly shown in FIG. 1;

FIG. 5 illustrates a partial exploded view of the trimmer head of the line trimmer assembly shown in FIG. 1; and

FIG. 6 illustrates a top view of a base of a support assembly of a line trimmer assembly, according to a further embodiment of the disclosure.

### DETAILED DESCRIPTION OF THE DRAWINGS

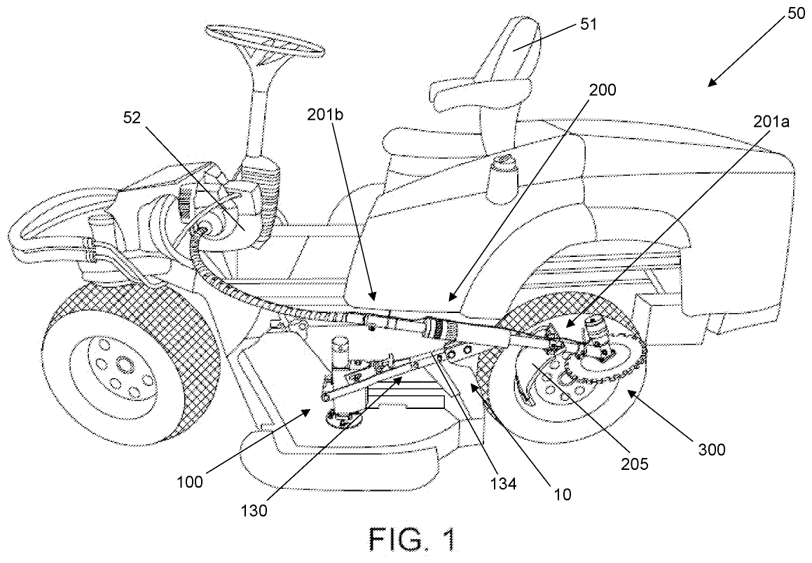

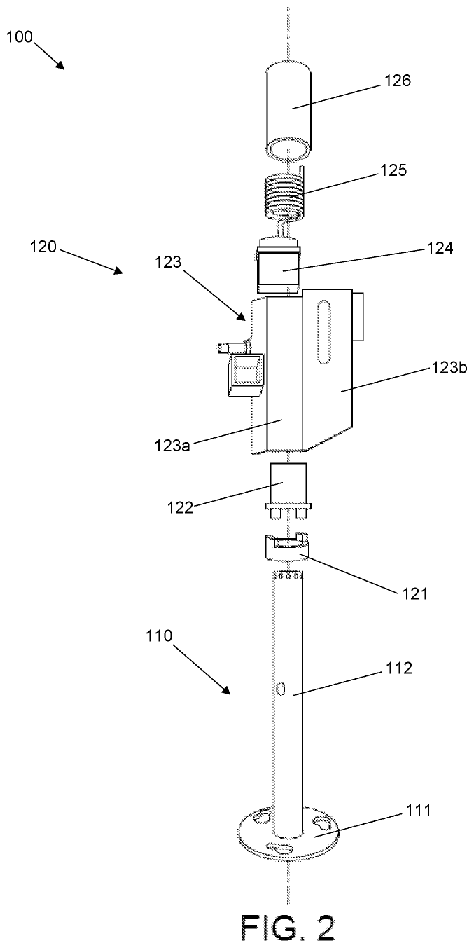

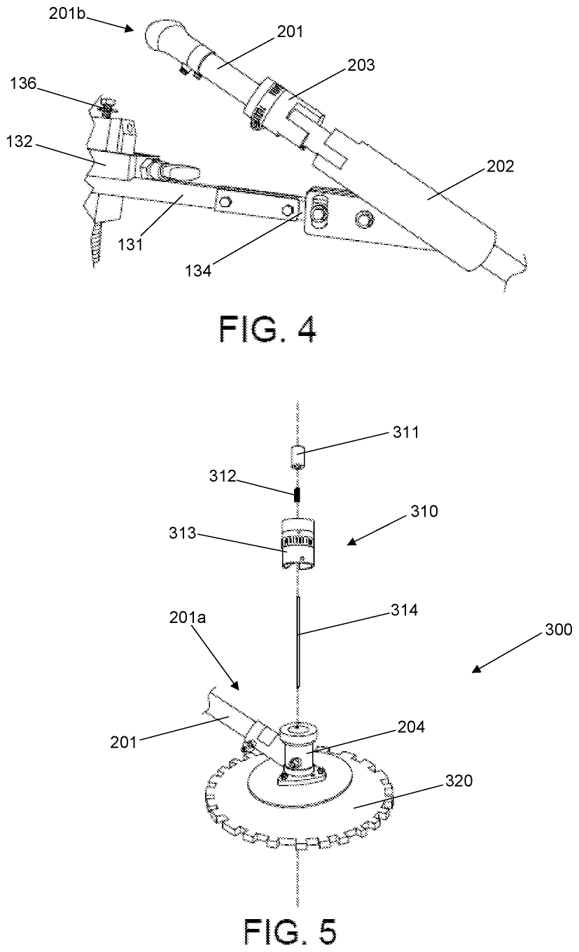

FIGS. 1-5 illustrate a line trimmer assembly 10 (or parts thereof) located on a vehicle 50, according to an embodiment of the disclosure. The line trimmer assembly 10 is used for cutting vegetation (grass, weeds etc) and includes a support assembly 100, a shaft 200 operably connected to the support assembly 100, and a trimmer head 300 connected to the shaft 200.

In this embodiment, the vehicle 50 is a ride-on lawn mower (for cutting vegetation such as grass) with a seat 51 for seating the driver/operator. However, in further embodiments, the vehicle 50 may have a different primary purpose and/or be configured to accommodate an operator in standing position only. Further, in this embodiment, the line trimmer assembly 10 is attached to a side portion of the body of the vehicle 50. However, in further embodiments, the line trimmer assembly 10 may be attached elsewhere on the body of the vehicle 50, for example, the front or rear portions of the body of the vehicle 50.

The support assembly 100 of the line trimmer assembly 10 comprises a base 110, a biasing assembly 120 connected to the base 110, and a frame 130 (in the form of an A-frame) connected to the biasing assembly 120. The base 110 includes a plate 111, in the form of a circular disc, with three apertures through which fasteners (in the form of nuts and bolts) can be located to attach the line trimmer assembly to vehicle 50, and a tube 112 upon which the biasing assembly 120 is located, the tube 112 being connected to the plate 111. However, in further embodiments, the plate 111 may include only one, two or four or more apertures, or the plate 111 may be connected to the vehicle in a different manner, for example, by clamping or welding.

The biasing assembly 120 comprises a collar 121, a first bush 122, a housing 123, a second bush 124, a torsion spring 125 and a cap 126. The collar 121 mates with the tube 112 of the base 110 and the first bush 122. In particular, the collar 121 includes a central bore through which the tube 112 extends and, when assembled, the collar 121 is non-rotatable with respect to the tube 112. The collar 121 further includes two projections on a planar surface of the collar 121, with the two projections being spaced from each other.

The first bush 122 also includes a central bore through which the tube 112 extends. However, when assembled, the first bush 122 (along with the housing 123) is rotatable with respect to the tube 112, but non-rotatable with respect to the housing 123. A first end of the first bush 122 engages with the housing and a second end (opposite to the first end) of the first bush 122 includes two projections spaced from each other, each projection of the first bush 122 selectively engaging with one of the projections of the collar 121 when the first bush 122 rotates relative to the collar 121 (and the tube 112). However, in further embodiments the collar 121 and/or the first bush 122 may include only one or three or more projections, or one of the collar 121 or the first bush 122 may include one or more recesses that engage with the projections of the other.

The rotational movement of the first bush 122 (and therefore, the biasing assembly 120 except the collar 121) relative to the collar 121 (and therefore, the base 110) is limited in either direction along an arc of a predetermined arcuate length so that the lateral swinging of the shaft 200 is also limited along the predetermined arc. In particular, the rotational movement of the first bush 122 is limited in either direction when either of the projections of the first bush 122 abuts one of the projections of the collar 121.

The housing 123 includes two portions—a first side portion 123a and a second side portion 123b, with the two side portions connected to each other along a longitudinal side of each side portion. The first side portion 123a has a hollow longitudinal portion with a bore extending along the entire length thereof, a hollow lateral portion with a bore extending along the entire length thereof, and a locking pin that releasably engages with a corresponding aperture on the tube 112 of the base 110. The lateral portion of the first side portion 123a and the second side portion 123b are connected to the frame 130.

In this embodiment, the longitudinal portion of the first side portion 123a has a square cross-sectional shape. However, in further embodiments, the bore may have a different cross-section shape, for example, circular, triangular or a differently shaped quadrilateral and/or the bore may extend only along a portion of the first side portion 123a.

When assembled, a portion of the first and second bushes 122, 124 and a portion of the tube 112 of the base 110 are received within the bore of the first side portion 123a of the housing 123. In particular, the lower end of the bore of the first side portion 123a receives a portion of the first bush 122 and a portion of the tube 112, and the upper end of the bore of the first side portion 123a receives a portion (a first end) of the second bush 124. The second end (opposite to the first end) of the second bush 124 is attached to the spring 125 and also engages with the cap 126, resulting in the spring 125 being enclosed by the cap 126 and the second bush 124 to prevent entry of debris.

The spring 125 of the biasing assembly 120 is in the form of a coiled compression spring and acts as a torsion spring to bias the shaft 200 towards a first position where the trimmer head 300 is located at a maximum predetermined distance from the body/chassis of the vehicle 50. The spring 125 the biasing assembly 120 biases the shaft 200 towards the first position and enables the shaft 200 to swing laterally back to the first position when a force is applied on the trimmer head 300, the force making the shaft 200 swing laterally towards the vehicle 50 such that a distance between the trimmer head 300 and the body of the vehicle 50 is reduced (compared to the distance between the trimmer head 300 and the body of the vehicle in the first position). Notably, upon application of appropriate force to the trimmer head 300, the shaft 200 is able to swing laterally towards the vehicle 50 until it reaches a second position where the trimmer head 300 is located at a minimum predetermined distance from the body of the vehicle 50. The maximum and minimum distances of the trimmer head 300 from the body of the vehicle 50 correspond to the predetermined limits to the rotation of the biasing assembly 120 (except the collar 121) relative to the base 110 (and the collar 121), and are set by the design of the projections (i.e. size of projections and distance between them) of the collar 121 and the first bush 122.

However, in further embodiments, any mechanically equivalent assembly of the biasing assembly 120 may be used to bias the shaft 200 towards the first position, or a different type of spring may be used in the biasing assembly 120, for example, a cantilever spring, a torsion bar/tube spring or a machined spring.

When the line trimmer assembly 10 is not in use or is being transported, the shaft 200 may be locked in the second position by engaging the locking pin of the first side portion 123a of the housing 123 with the corresponding aperture on the tube 112 of the base 110.

The frame 130 comprises a pair of outer arms 131 and a U-shaped locking member 132 with a locking pin 133 located thereon. However, in further embodiments, the locking member 132 may be differently shaped or the locking pin 133 may be directly connected to the pair of outer arms 131. The outer arms 131 are connected to the parallel arms of the locking member 132, with each of the outer arms 131 being connected to a respective arm of the locking member 132 such that a minimum distance between the pair of outer arms 131 is maintained.

The distance between the outer arms 131 at proximal ends thereof (the ends that are connected to the biasing assembly) is greater than the distance between the outer arms 131 at distal ends (the ends that are connected to the shaft) thereof. The distance between the outer arms 131 at their proximal ends is set such that the outer arms 131 can be connected to the lateral portion of the first side portion 123a via a hollow shaft and bolts extending through the lateral portion of the first side portion 123a and apertures at the proximal ends of the outer arms 131. Thus, the connection of the proximal ends of the outer arms 131 with the first side portion 123a of the housing 123 provides a point about which the shaft 200 is able to pivot/move between a raised position and a lowered position to allow a distance between the trimmer head 300 and the ground to be adjusted. Similarly, the distance between the outer arms 131 at their distal ends is set such that a connecting member 134 can be received in between (and fastened to) the outer arms 131, the connecting member 134 connecting the frame 130 to the shaft 200.

As noted above, the second side portion 123b of the housing 123 is also connected to the frame 130. The second side portion 123b is in the form of a hollow longitudinal portion, the second side portion 123b having an aperture located on a longitudinal side thereof (and near the upper end of the longitudinal portion) that is opposite to the longitudinal side of the second side portion 123b that is attached to the first side portion 123a. The second side portion 123b further includes two elongate cut-outs, each cut-out being located on a respective longitudinal side that is adjacent to the longitudinal side of the second side portion 123b which is attached to the first side portion 123a. A floating member (not shown) is received in the hollow of the second side portion 123b, the floating member having two bolts 135 extending from opposite sides thereof and through the elongate cut-outs of the second side portion 123b. The bolts 135 of the floating member are sized such that they can freely move (up and down) along the length of the cut-outs. The bolts 135 are connected to the locking member 132 of the frame 130 by locating each bolt 135 through a respective elongate cut-out in each of the parallel arms of the locking member 132. The floating member further includes a central bore through which a coiled spring (not shown) is located.

An elongate adjusting bolt 136 extends through the hollow of the second side portion 123b from an aperture located on a top surface of the second side portion 123b (at the upper end of the second side portion 123b), the elongate bolt 136 also extending through the central bore of the floating member and through the coiled spring, and having an adjusting nut (not shown) connected to an end thereof (the end that extends out from and beyond the floating member). The adjusting nut is located in the hollow of the second side portion 123b and is able to move along the adjusting bolt 136 relative to the second side portion 123b. The distance between the trimmer head 300 and the ground can be adjusted via manipulation of the adjusting bolt 136 which moves the adjusting nut which exerts a force on the coiled spring, and the coiled spring transfers the force to the floating block and bolts 135 which are connected to the frame 130. Further, when the distance between the trimmer head 300 and the ground has been adjusted, the coiled spring still allows for minor changes in the distance between the trimmer head 300 and the ground if an upward force is exerted on the trimmer head 300. Moreover, a predetermined maximum and minimum height of the trimmer head 300 from the ground can be set by the size (in particular, the length) of the cut-outs of the second side portion 123b.

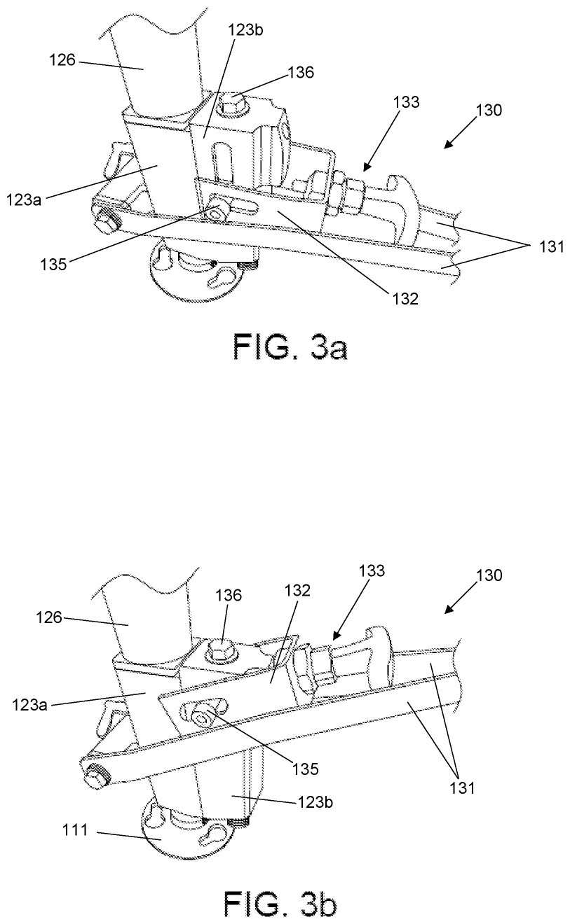

The locking pin 133 of the locking member 132 of the frame 130 can be engaged with the aperture located on the longitudinal side of the second side portion 123b that is opposite to the longitudinal side of the second side portion 123b that is attached to the first side portion 123a. This allows the shaft 200 (and the trimmer head 300) to move from a lowered position (when the locking pin 133 is not engaged, as shown in FIG. 3a) to a raised position (when the locking pin 133 has been engaged with the relevant aperture, as shown in FIG. 3b), with the distance between the trimmer head 300 and the ground being greater in the raised position than in the lowered position. The locking pin 133 allows the line trimmer assembly 10 to be locked in the raised position when the line trimmer assembly 10 is not in use or is being transported. However, in further embodiments, the support assembly 100 may include a different but mechanically equivalent locking mechanism that allows the shaft 200 to be locked in the raised position.

The shaft 200 includes a hollow tubular member 201 which extends through two bushes—a first bush 202 that is connected to the frame 130 via the connecting member 134, and a second bush 203 that releasably engages with the first bush 202. The first bush 202 includes a pair of projections with apertures through which fasteners are located to connect the first bush 202 to the connecting member 134, the fasteners also extending through the connecting member 134. One of the apertures located on each of the projections of the first bush 202, through which a single fastener is located, are elongate in shape such that the angle between the tubular member 202 and the frame 130 can be adjusted, which allows the angle of the trimmer head 300 relative to the ground to be adjusted.

The tubular member 201 can slide axially relative to the first and second bushes 202, 203. However, in use, the second bush 203 is clamped onto the tubular member 201 at a desired point along the tubular member 201, allowing the distance between the trimmer head 300 and the support assembly 100 to be set/adjusted, as well as the angle of the trimmer head 300 relative to the ground.

The first bush 202 includes a plurality of projections at an end of the first bush 202 that engages with the second bush 203, the projections of the first bush 202 being located circumferentially about the longitudinal axis of the tubular member 201 and extending towards the second bush 203. Similarly, the second bush 203 includes a plurality of corresponding projections at an end of the second bush 203 that engages with the first bush 202, the projections of the second bush 203 also being located circumferentially about the longitudinal axis of the tubular member 201 and extending towards the first bush 202. The projections of the first and second bushes 202, 203 allow the first and second bushes 202, 203 to engage with each other in multiple configurations. In particular, as the second bush 203 is clamped onto the tubular member 201, changing the mating configuration of the first and second bushes 202, 203 allows the tubular member 201 to be rotated about its longitudinal axis to a desired position and to be fixed in that position (if desired) for servicing (or easy access to) the trimmer head 300, as rotation of the tubular member 201 about its longitudinal axis also rotates the trimmer head 300 about the longitudinal axis of the tubular member 201. Moreover, as the tubular member 201 is slideable relative to the first bush 202, force exerted on the trimmer head 300 (for example, if the line trimmer assembly 10 is backed onto and against an object) allows the second bush 203 to disengage from the first bush 202, thereby allowing the tubular member 201 to slide through the first bush 202 such that a distance between the first bush 202 and the trimmer head 300 is reduced. This prevents damage to the line trimmer assembly 10 if it is backed onto and against an object. The shaft 200 further includes a safety switch (not shown) that detects disengagement of the second bush 203 from the first bush 202 and, in response, cuts off the power supply to the trimmer head, thereby ensuring that the trimmer head 300 cannot be operational when the second bush 203 is disengaged from the first bush 202 (for servicing the trimmer head 300 or when the line trimmer assembly 10 is backed onto and against an object).

The distal end 201a of the tubular member 201 includes a gear head 204 which is connected to the trimmer head 300 and includes a central throughbore, while the proximal end 201b of the tubular member 201 is connected to a power source 52 (in the form of an electric motor) located on the vehicle 50 via a cable (as shown in FIG. 1). A flexible drive shaft extends through the cable and through the tubular member 201, transmitting power from the power source 52 to the trimmer head 300. However, in further embodiments, the power source 52 may be a different type of motor/engine, for example, a petrol or diesel engine, or the line trimmer assembly 10 may be powered by the same engine/motor that powers the vehicle 50. Moreover, in further embodiments, the power source 52 may be connected to the distal end 201a of the tubular member 201 of the shaft 200 and/or may be located on the shaft 200. Moreover, in further embodiments, the power source 52 may be directly connected to the distal end 201a or the proximal end 201b of the tubular member 201 of the shaft 200 and may be located on the tubular member 201 at any point along the tubular member 201 (including the distal end 201a or the proximal end 201b).

A cover 205 (in the form of a curved plate) is located adjacent to the distal end 201a of the tubular member 201 and acts a protective shield to prevent debris from being blown towards the driver/operator of the vehicle 50.

The trimmer head 300 comprises a cord release assembly 310, a floating disc 320 and a trimmer 330 (not shown). The cord release assembly 310 is connected to the gear head 204 at an upper end thereof (the end that is opposite to the end of the gear head 204 that is configured to be located over the ground) and comprises a plunger 311, a spring 312, a magnet 313 (located in a housing) and a rod 314. The magnet 313 includes a central throughbore and is attached to the gear head 204 such that the central throughbores of the magnet 313 and the gear head 204 are co-axial. The plunger 311, the spring 312 and a portion of the rod 314 are located in the throughbore of the magnet 313, with the spring 312 located between the plunger 311 and the rod 314 so that the spring 312 counteracts the weight of the plunger 311 such that the plunger 311 and the rod 314 only come into contact when the magnet 313 is activated. The rod 314 extends from (and partially through) the throughbore of the magnet 313, through the throughbore of the gear head 204 and a hollow drive shaft (not shown) located through the gear head 204 and extending past the lower end of the gear head 204. A portion of the rod 314 extends past the drive shaft and engages with the trimmer 330.

As the drive shaft and rod 314 rotate at high speeds (when the line trimmer assembly 10 is being operated), a thrust bearing is located in the throughbore of the magnet 313 so that no rotational force is transferred to the plunger 311.

The floating disc 320 is located concentrically between two immobile discs (only one shown in FIGS. 1 and 5) that are fixed and immobile relative to the gear head 204, while the floating disc 320 is freely rotatable relative to the two immobile discs and the gear head 204. The circumferential edge of the floating disc 320 has a series of projections extending along its entire length and the diameter of the floating disc 320 is greater than that of the two immobile discs such that the circumferential edge of the floating disc 320 extends beyond the two immobile discs. This allows a minimum distance between the trimmer 330 and any structure (around which the trimmer head 300 is being used) to be set by picking a floating disc 320 of an appropriate radius. Further, as the floating disc 320 is freely rotatable relative to the gear head 204, upon contact with any structure (around which the trimmer head 300 is being used), the floating disc 320 rotates as it is moved along the surface of the structure (by the movement of the vehicle 50), thereby minimizing damage to the structure and also any impact such contact may have on the line trimmer assembly 10.

The trimmer 330 is located at the lower end of the gear head 204, below the two immobile discs and the floating disc 320, and includes the cord used for cutting vegetation (including excess cord to be released). The trimmer head 330 is connected to gear head 204 via the drive shaft, the rotation of the drive shaft causing the trimmer 330 to rotate.

When the magnet 313 is activated, the plunger 311 is pulled towards the rod 314, pushing the rod 314 downwardly towards the trimmer 330. This movement of the rod 314 causes further cord to be released from the trimmer 330. However, in further embodiments, the rod 314 may be configured such that activation of the magnet 313 pulls the rod 314 upwardly away from the trimmer 330 which would result in further cord being released from the trimmer 330. Moreover, in further embodiments, the movement of the rod 314 or causing the trimmer 330 to release further cord may be achieved by an electric motor and/or a gearbox. The magnet 313 is activated by a switch located in proximity to the seat 51 of the vehicle 50 such that the driver/operator of the vehicle 50 may easily actuate the magnet 313 (when needed) when driving the vehicle 50, without requiring to stop the vehicle 50. However, in further embodiments, the switch for the magnet 313 may be located elsewhere on the vehicle 50 or the line trimmer assembly 10, or the magnet 313 may be activated automatically upon detection of conditions that require release of further cord (such as when the already released cord has worn down to a pre-determined length).

When the line trimmer assembly 10 is to be used, the shaft 200 is first moved to the lowered position by using the locking pin 133 to unlock the shaft 200 locked in the raised position. Next, the locking pin of the first side portion 123a of the housing 123 is used to unlock the shaft 200 from the second position, which allows the shaft 200 to move to the first position (where the trimmer head 300 is located at a maximum predetermined distance from the body/chassis of the vehicle 50). The trimmer 330 is then activated by turning on the line trimmer assembly 10 from the power source 52. As the vehicle 50 moves, the trimmer 330 cuts any vegetation that comes into contact with the released cord.

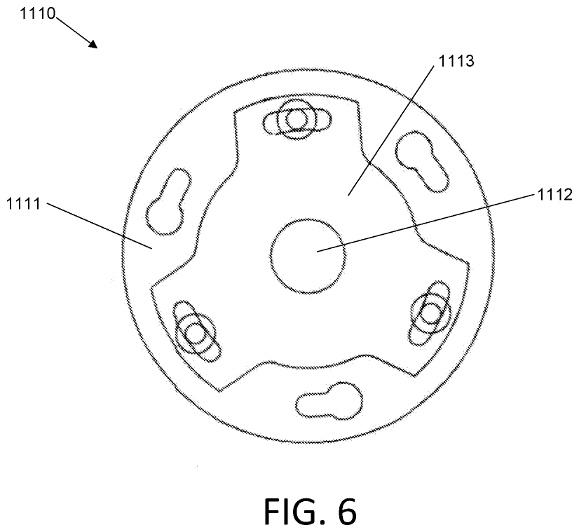

FIG. 6 illustrates a base 1110 of a support assembly 1100 of a line trimmer assembly 20, according to a further embodiment of the disclosure. The line trimmer assembly 20 is substantially similar to the line trimmer assembly 10 but differences therebetween are noted below.

Like the line trimmer assembly 10, the line trimmer assembly 20 includes a support assembly 1100 with a base 1110. However, the base 1110 comprises a base plate 1111, an adjusting plate 1113 connected to the base plate 1111 via fasteners, and a tube 1112 fixedly connected to the adjusting plate 1113. The base plate 1111 is shaped like a circular disc and has two sets of apertures—a first plurality of apertures and a second plurality of apertures—with each set comprising three identical apertures spaced from each other along the outer edge of the base plate 1111. The first plurality of apertures are for connecting the base plate to the vehicle 50 by locating fasteners (in the form of nuts and bolts) through the apertures. The second plurality of apertures are elongate in shape and are configured to receive fasteners therethrough to attach the adjusting plate 1113 to the base plate 1111.

The adjusting plate 1113 is in the shape of a circular disc with three equally spaced projections, each projection includes an elongate aperture. The diameter of the adjusting plate 1113 is less than the diameter of the base plate 1111. A fastener is located through each aperture of the adjusting plate 1113 and through a respective aperture of the second plurality of apertures of the base plate 1111 to connect the adjusting plate 1113 to the base plate 1111.

The elongate shape of the apertures of the adjusting plate 1113 and the apertures of the second plurality of apertures of the base plate 1111 allows for further adjustment of the position of the rest of the line trimmer assembly 20 relative to the body of the vehicle 50 (including adjustment of the maximum and minimum distances of the trimmer head from the body of the vehicle 50). Moreover, the base 1110 allows for easy installation and removal of the line trimmer assembly 20 on/from the vehicle 50.

The line trimmer assembly 10 presents several advantages over hand-held or wheeled/walk-behind type line trimmers that require significantly more manual control by the operator. As the line trimmer assembly 10 can be attached to a side portion of the vehicle 50 (for example, a lawn mower), two functions can be performed at the same time, i.e. the primary function of the vehicle 50 (for example, cutting grass if the vehicle 50 is a lawn mower) and cutting vegetation by the line trimmer assembly 10. Further, the location of the line trimmer assembly on the vehicle 50 ensures sufficient distance between the trimmer head 300 and the driver/operator of the vehicle 50. The line trimmer assembly 10 can also be easily attached to or removed from the vehicle 50 without requiring a high level of skill, thereby allowing it to be retrofitted onto existing vehicles. Moreover, the cord release assembly 310 enables further cord to be released from the trimmer 330 with the activation of a switch by the driver/operator without having to stop the vehicle 50 or any other interruptions to the use of the line trimmer assembly 10.

In this specification, adjectives such as first and second, forward and backward, upward and downward, top and bottom, upper and lower, proximal and distal, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present disclosure is provided for purposes of description to one of ordinary skill in the related art. It is not intended to be exhaustive or to limit the disclosure to a single disclosed embodiment. As mentioned above, numerous alternatives and variations to the present disclosure will be apparent to those skilled in the art of the above teaching. Accordingly, while some alternative embodiments have been discussed specifically, other embodiments will be apparent or relatively easily developed by those of ordinary skill in the art. The disclosure is intended to embrace all alternatives, modifications, and variations of the present disclosure that have been discussed herein, and other embodiments that fall within the spirit and scope of the above described disclosure.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1.-26. (canceled)

27. A line trimmer assembly locatable on a vehicle configured to seat an operator, the line trimmer assembly comprising:
a support assembly comprising a base configured to be attached to the vehicle and a biasing assembly configured to rotate relative to the base;
a shaft operably connected to the support assembly;
a trimmer head connected to a distal end of the shaft, the trimmer head being configured to cut vegetation;
wherein the biasing assembly is configured to enable the shaft to swing laterally between a first position and a second position, and the biasing assembly biases the shaft towards the first position, and
wherein the shaft is configured to move between a raised position and a lowered position to allow a distance between the trimmer head and the ground to be adjusted.

28. The line trimmer assembly of claim 27, a distance between the trimmer head and a body of the vehicle is greater in the first position than in the second position.

29. The line trimmer assembly of claim 27, wherein the line trimmer assembly is attached to a side portion, front portion or rear portion of the body of the vehicle.

30. The line trimmer of claim 27, wherein the base of the support assembly comprises a plate and a tube connected to the plate.

31. The line trimmer of claim 30, wherein biasing assembly comprises a collar that mates with the tube, and a housing through which a portion of the tube extends.

32. The line trimmer of claim 31, wherein biasing assembly further comprises a first bush, and wherein a first end of the first bush engages with the housing and a second end of the first bush includes two projections spaced from each other that selectively engage with the collar.

33. The line trimmer of claim 32, wherein rotational movement of the first bush relative to the collar is limited in either direction along an arc of a predetermined arcuate length such that the lateral swinging of the shaft is also limited along the arc, or a portion of the first bush and a portion of the tube of the base are received within a bore of a first side portion of the housing.

34. The line trimmer of claim 31, wherein the shaft is lockable in the second position by engaging a locking pin of the housing with an aperture on the tube of the base, or the support assembly further comprises a frame connected to the biasing assembly, the frame comprising a pair of outer arms and a locking member.

35. The line trimmer assembly of claim 34, wherein a connecting member is received between distal ends of the outer arms, the connecting member connecting the frame to the shaft.

36. The line trimmer assembly of claim 34, wherein the locking member is configured to engage with an aperture of a second side portion of the housing, and the shaft is locked in the raised position when the locking member is engaged with the aperture of the second side portion of the housing.

37. The line trimmer assembly of claim 36, wherein the second side portion includes two elongate cut-outs, a length of each of the cut-outs determining a maximum and minimum distance of the trimmer head from the ground.

38. The line trimmer assembly of claim 36, wherein the distance between the trimmer head and the ground can be adjusted by an adjusting bolt that extends through the second side portion.

39. The line trimmer of claim 35, wherein the shaft comprises a tubular member that extends through a first bush and a second bush.

40. The line trimmer of claim 39, wherein the first and second bushes of the shaft are engageable with each other in multiple configurations, and wherein changing a mating configuration of the first and second bushes of the shaft allows the trimmer head to be rotated about a longitudinal axis of the tubular member.

41. The line trimmer of claim 40, wherein disengagement of the second bush of the shaft from the first bush of the shaft can be detected by a safety switch that cuts off power supply to the trimmer head when the second bush of the shaft disengages from the first bush of the shaft.

42. The line trimmer of claim 27, wherein the trimmer head comprises a cord release assembly.

43. The line trimmer of claim 42 wherein, the cord release assembly comprises a plunger, a spring, a magnet and a rod, and wherein the plunger, the spring and a portion of the rod are located in a central throughbore of the magnet.

44. The line trimmer of claim 43, wherein the magnet of the cord release assembly is activated by a switch located on the vehicle or the line trimmer assembly.

45. A system for cutting vegetation, the system comprising:
a vehicle comprising a seat to seat an operator; and
a line trimmer assembly located on the vehicle, the line trimmer assembly comprising:
a support assembly comprising a base attached to the vehicle and a biasing assembly configured to rotate relative to the base;
a shaft operably connected to the support assembly;
a trimmer head connected to a distal end of the shaft, the trimmer head being configured to cut vegetation;
wherein the biasing assembly is configured to enable the shaft to swing laterally between a first position and a second position, and the biasing assembly biases the shaft towards the first position, and
wherein the shaft is configured to move between a raised position and a lowered position to allow a distance between the trimmer head and the ground to be adjusted.

46. A method for cutting vegetation, the method comprising:
moving a shaft of a line trimmer assembly to a lowered position from a raised position, the shaft having a trimmer head connected to a distal end thereof;
moving the shaft to a first position from a second position, the shaft being biased towards the first position by a biasing assembly operatively connected to the shaft;
activating a trimmer located on the trimmer head, the trimmer being configured to cut vegetation,
wherein the line trimmer assembly is located on a vehicle configured to seat an operator.
